(19) United States
(12) Patent Application Publication
(10) Pub. No.: US 2026/0052142 A1
(43) Pub. Date: Feb. 19, 2026

(54) BROWSER OBJECT MODEL VALUE-BASED RESPONSES

(71) Applicant: Wells Fargo Bank, N.A., San Francisco, CA (US)

(72) Inventor: Michael J. Quinlan, San Francisco, CA (US)

(21) Appl. No.: 18/802,448

(22) Filed: Aug. 13, 2024

(51) Int. Cl. H04L 9/40; H04L 9/08

(52) U.S. Cl. CPC H04L 63/083; H04L 9/0872

(57) ABSTRACT

A method may include: receiving, from a web browser on a computing device a login request with user credentials and browser object model (BOM) data of the web browser; querying an identifier database for an entry matching a portion of the BOM data; accessing a successful user login count for the entry; comparing the successful user login count to a clearance threshold; based on the comparison: determining that the successful user login count is below the clearance threshold; and modifying a login difficulty for the login request; processing, at the web server, the login request with the user credentials and the modified login difficulty; receiving an indication that the processing resulted in a successful user login; and in response to the indication, increasing the successful user login count for the entry.

### BACKGROUND

Many people reuse emails, usernames, and passwords. The risk of doing so is that if a person's login information is stolen from one website, it may be used on another website. However, when a database of credentials is stolen it may include millions of email/password or username/password combinations. To test the credentials, automated attacks are used on web infrastructure (e.g., web applications, services, etc.) to determine which credentials are valid for different websites.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a block diagram illustrating operations for responding to login requests, according to various examples.

FIG. 3 is a block diagram flowchart 300 of a method to respond to login requests, according to various examples.

FIG. 4 is a block diagram illustrating a machine in the example form of computer system 400, within which a set or sequence of instructions may be executed to cause the machine to perform any one of the methodologies discussed herein, according to various examples.

### DETAILED DESCRIPTION

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface”does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

It is challenging to distinguish between legitimate and illegitimate bots on web applications. As noted, there are often automated browser attacks that use login forms to determine if user credentials are valid. The problem is compounded by the variability and evolution of browser configurations used by both genuine users and malicious bots. Also, the dynamic nature of browser updates and plugin installations complicates the reliability of using any unique identifier to filter out bots.

For example, one solution may be to compare identifiers in the browser object model (BOM) to known identifiers. If an identifier is unknown, a challenge method (e.g., stepped-up authentication) may be used to slow down or stop an automated attack. However, this brute-force approach will result in many false positives that affect legitimate users. Furthermore, any attempt to manually enter “good” identifiers is untenable due to the volume of browsers, plugins, and rapid update cycles.

The following describes systems and methods to track identifiers in association with successful login attempts to quickly determine the identifiers that are valid versus identifiers associated with automated bots. For example, during a login request from a computing device, a new, unknown, identifier may be added to a database. If the login request is successful, a successful user login count may be increased in the database for the new identifier. Thereafter, for each successful login that has the new identifier, the successful user login count may be increased. Once the successful user login count has reached a clearance threshold, the new identifier may be cleared and considered associated with legitimate users. Thus, if the identifier is seen again, no additional challenges may be needed.

The described solution provides many benefits. By using a clearance threshold, the period in which false positives may occur is significantly reduced. Additionally, the solution does not require knowledge of the new identifiers ahead of time or queries to external services for identifiers. For example, even if a user is using their own custom plugin, any identifiers of the plugin would be cleared in the same manner as an identifier of a major web browser release. Further benefits may be apparent to one having ordinary skill in the art upon review of this disclosure.

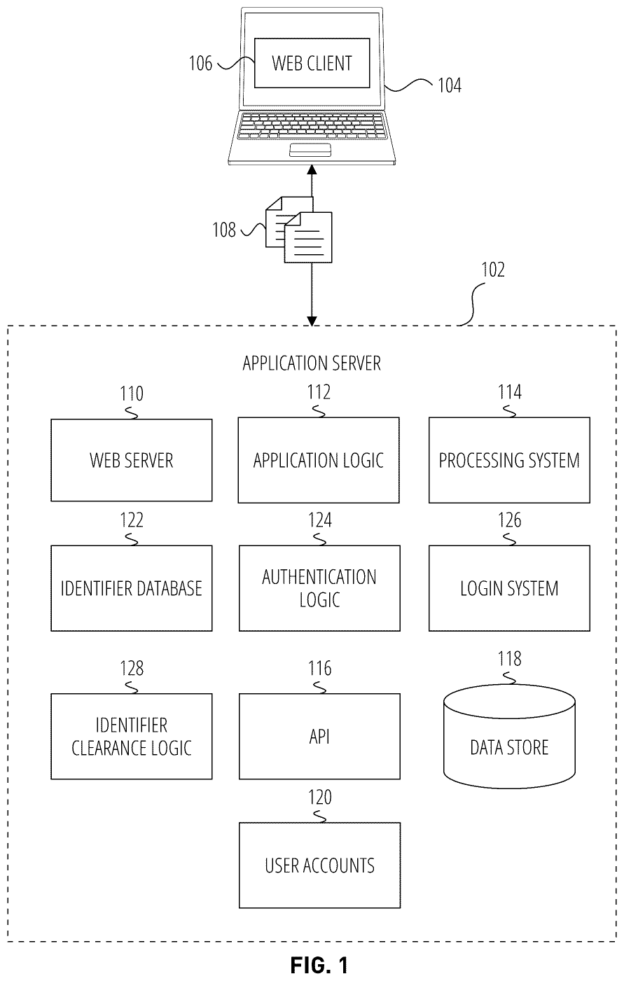

FIG. 1 illustrates the components of a client device and an application server according to various examples. Application server 102 is illustrated as separate elements (e.g., logic, systems, etc.). However, the functionality of multiple individual elements may be performed by a single element. An element may represent computer program code executable by processing system 114. The program code may be stored on a storage device (e.g., data store 118) and loaded into the memory of the processing system 114 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page rendered on a client device's display device (e.g., a mobile phone, desktop computer, etc.).

In some examples, the communication may occur using an application programming interface (API) such as API 116. An API provides a method for computing processes to exchange data. A web-based API (e.g., API 116) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database (e.g., data store 118). API 116 may be used to authenticate users via authentication logic 124 and transmit BOM data 108.

Additionally, web server 110 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 118) in various examples.

The web application may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the web server. Application logic 112 may use other elements (e.g., identifier database 122, authentication logic 124, login system 126, etc.) of application server 102 to perform functionality associated with the web application as described further herein.

The web application may be a banking application, a health care application, a gaming application, a social media application, etc. The web application may include a login page to access a user's information. For example, user accounts 120 may include user profiles on users of web applications served by application server 102. A user profile may include user credential information such as a username and hash of a password. The identifier database 122, authentication logic 124, login system 126, and identifier clearance logic 128 may work together to process login requests from client devices.

The identifier database 122 may be structured to include entries for identifiers derived from the BOM data of users'web browsers. The BOM is a framework that enables JavaScript to interact with the web browser environment. It provides a hierarchical collection of objects that represent the browser window, allowing for manipulation and control beyond the web page's content. The main component of the BOM is the window object, which serves as the global object in a browser context and encompasses various properties and methods for managing the browser window. Some properties of the window object include ‘document’, which represents the Document Object Model (DOM) of the current webpage; ‘location,’ which provides information about the current URL and allows for navigation and redirection; ‘history,’ which offers methods for interacting with the session history; ‘navigator,’ which supplies details about the browser and operating system; and ‘screen,’ which gives information about the user's screen dimensions and resolution.

The BOM's structure allows JavaScript to retrieve and manipulate values that have been set by the browser or through installed plugins. For example, the navigator object may be used to access information about the browser version and the user's operating system, which may have been populated by the browser or enhanced by plugins. An automated browser, such as those used in web scraping or automated testing (e.g., Selenium WebDriver®), can inject or modify information in the BOM to simulate different environments or user behaviors.

Additionally, an automated browser or a script running within a web page may extend the navigator object by adding custom properties or keys. A property may refer to the named values or attributes of an object. Each property includes a key (or name) and a value. Keys may refer specifically to the names of the properties within an object. Keys may be strings and are used to access the corresponding values. For example, in the object {userAgent: “Mozilla/5.0”}, “userAgent” is a key. A JavaScript call in a login page served by web server 110 may include a call such as “console.log(Object.keys(navigator))”. This call would output all of the keys of the navigator object, including any custom keys made by an automated browser, plugins, etc., to a console output. Instead of the console, the results of the call may be transmitted to application server 102.

An entry in the identifier database 122 may be based on information received from a JavaScript call executing on web client 106. For example, an identifier may be a key, a value of a key, a property (e.g., key/value pair), an object tree (e.g., the object and its child objects), or combinations thereof. Additionally, instead of the direct key, value, or property, an identifier may be a hash of the underlying data. An entry may also include a successful user login count value and a clearance threshold value. These values will be discussed in more detail in the subsequent figures. The names and number of columns of identifier database 122 (and other discussed data structures) are just one example, and others may be used.

The login system 126 may present a login form on a web page served from the web server 110. In various examples, the login system 126 receives user credentials, such as usernames and passwords, entered into the login form. The form may be rendered as part of a web page that is transmitted to and displayed on the client device 104. Users may enter their credentials into the form fields and submit the information (e.g., by clicking a ‘submit’button).

Upon submission, the login system 126 may capture the entered information and pass it to the authentication logic 124 via API 116. The authentication logic 124 may process the credentials to verify the identity of the user by comparing a hash of the entered credentials against a database of authorized users (e.g., data store 118). If the credentials match an existing entry in the database, the authentication logic 124 may allow access to the secured sections of the web application.

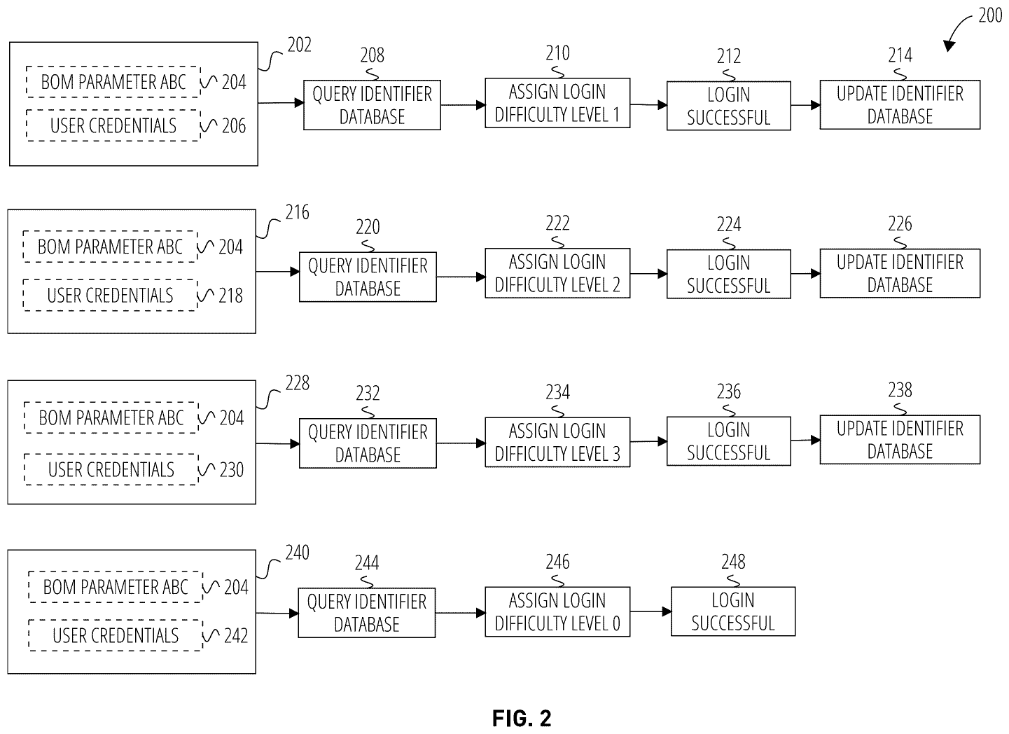

The authentication logic 124 may also implement a login difficulty when receiving a login request from login system 126. The login difficulty may be based on various risk systems. For example, if a risk system indicates an automated attack is occurring, the login difficulty may be increased. A login difficulty may be increased in different methods. One method may be to require further information (e.g., a one-time passcode). Another method may increase the amount of time between login attempts. Yet another method may employ a proof of work scheme (performed by web client 106) that increases computational difficulty and, therefore, slows down the speed at which login attempts may be made. One risk system may be based on identifiers in the BOM data 108 as processed by identifier clearance logic 128. An example of processing a login request using identifier clearance logic 128 is described in FIG. 2.

Data store 118 may store data that is used by application server 102 (e.g., identifier database 122, user accounts 120). Data store 118 is depicted as a singular element but may be multiple data stores. The data store 118 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may be implemented as a struct or class. In the context of a relational database, a data structure may be defined in a schema.

FIG. 2 is a block diagram 200 illustrating operations for responding to login requests, according to various examples. FIG. 2 shows operations occurring in a particular sequence (e.g., left to right), but the operations may be performed in other orders or simultaneously. The operations of diagram 200 represent a series of login requests from four different users. The login requests may be transmitted from computing devices such as a client device 104 to a web server (e.g., web server 110). For FIG. 2, consider that a web browser has been updated, and as part of the update, the web browser has added a new parameter to the BOM. Each of the four login requests may be using the updated web browser that has the new parameter in the BOM.

The login request 202 may originate from a web browser executing on a computing device after a user has entered user credentials 206 into a login form rendered on a display device. The web page presenting the login form may include JavaScript code that queries the BOM data of the web browser. The query may be configured to retrieve the entire BOM, a specific part of the BOM, a random part of the BOM, or unknown parts of the BOM. For example, queries may be directed to certain objects in the BOM (e.g., the navigator object).

The code may filter out known “good” parameters in the BOM before transmitting BOM data from the computing device. For example, a database (e.g., identifier database 122) may store parameters that have a successful user login count above a clearance threshold. Once a parameter has passed such a threshold the login request 202 may forgo sending data on the parameter. To facilitate the filtering, the JavaScript code may store hashes (or the keys, values themselves) of the known “good” parameters and compare them against hashes of the BOM data of the web browser executing the code.

Consider that after the JavaScript code is executed and queried the BOM, the results show a new parameter with a key of “ABC.” Accordingly, the computing device may include an identifier of the key in BOM data 204 with user credentials 206 as part of login request 202. The identifier may be the name of the key, a key/value pair, etc., or hashes thereof. Furthermore, the BOM data 204 is illustrated as being part of login request 202 but may be transmitted separately. In various examples, a login request may be received at a web server, and, in response, a request for BOM data 204 may be transmitted.

The login request 202 may be received and processed to determine if the user credentials are valid and what login difficulty to use for the login request 202. For example, a component such as authentication logic 124 may be used to verify the user credentials (e.g., compare the received user credentials to stored user credentials).

Additionally, BOM data 204 may be used as the basis to perform the query identifier database operation 208. For example, if the key name was included in BOM data 204, the key name would be used with the query, or if a hash was used in BOM data 204, the hash would be used for the query. The query may be directed towards a database, such as identifier database 122. For login request 202, the query may result in zero matches. Accordingly, a new entry may be generated using BOM data 204.

The new entry may include an identifier of the BOM data (e.g., hash, key, key: value), a successful user login count, and a clearance threshold. A login may be considered successful at authentication operation 212 when the user credentials received in the login request are verified and any other stepped-up authentication requests are completed. The stepped-up authentication may be selected (e.g., using a lookup table) based on the login difficulty for the entry. Although the example in FIG. 2 describes an increasing level of login difficulty at each login request, other login difficulty level schemes may be used. For example, a default level of two may be used until the clearance threshold is met regardless of the successful user login count. Or, the initial login difficulty may be a three and decreased for each successful user login.

When a new entry is created, assign login difficulty operation 210 may be performed. An initial login difficulty may be a “one.” A level one login difficulty may be an increase over a default login difficulty of zero where no stepped-up authentication or challenge methods are used. Increases in login difficulty may use timers or proof-of-work as described in FIG. 1.

After authentication operation 212 results in a successful login, update identifier database operation 214 may be performed. Update identifier database operation 214 may be performed at the same time a new entry is generated. For example, the entry may be generated, and the successful user login count may be set to one based on authentication operation 212. However, in instances where authentication operation 212 was unsuccessful, the entry may be created with a zero in the successful user login count column.

Update identifier database operation 214 may also set a clearance threshold for the new entry. The clearance threshold may have a default value of three. However, the clearance threshold may be modified depending on the contextual data of the login request. For example, a risk model may use geolocation data (e.g., based on IP), time, frequency of login requests originating from the device, browser fingerprint, etc., to calculate the probability the login request is a bot or automated attack. The risk model may be a regression model or neural network trained on past labeled datasets that use geolocation data, time, and frequency and classification of the login request as valid or invalid (e.g., bot activity). If the output of the risk model indicates a probability above a certain threshold (e.g., outputs 0.8, corresponding to 80%) that login request 202 is invalid, the clearance threshold may be increased (e.g., to five). The risk model may also incorporate past user interaction data to use as a baseline such as the time of prior logins, frequency of browser upgrade, and behavioral characteristics such as keystroke patterns. Accordingly, the clearance threshold may be changed if there is a deviation (e.g., above a nominal or standard deviation threshold) between a current login request and an average of past user interactions.

Subsequent to login request 202 being received at a web server, login request 216 may be received. Login request 216 may be from a different computing device than login request 202, but use the same version of a web browser. Accordingly, the user credentials in login request 216 (e.g., 218) differ from login request 202, the same BOM data 204 may be transmitted. At query identifier database operation 220, the entry in the identifier database created after login request 202 may be discovered based on BOM data 204. At assign login difficulty operation 222, the login difficulty may be set to level two (e.g., adding in a delay before an authentication result is displayed) based on the current value of one in the successful user login count of the entry. At authentication operation 224, the user credentials 218 are checked and determined to be valid. Accordingly, the successful user login count may be increased to two at update identifier database operation 226.

The process repeats again using login request 228 from a third computing device with a different set of user credentials (e.g., user credentials 242). At this stage, query identifier database operation 232 finds the entry for the BOM data 204 and assign login difficulty operation 234 results in a login difficulty of level 3 (e.g., a proof of work calculation). At authentication operation 236, the user credentials 230 are checked and determined to be valid. Accordingly, the successful user login count may be increased to three. However, now that the successful user login count matches the clearance threshold (e.g., three), the entry may be updated (e.g., a flag may be set in a column by identifier clearance logic 128) to indicate that BOM data 204 is not associated with an automated browser/script.

Thus, at login request 240, which includes the BOM data 204, query identifier database operation 244 may return the updated entry after update identifier database operation 238. Either based on the indication in the entry or a comparison between the successful user login count and the clearance threshold, a login difficulty level of zero may be set at assign login difficulty operation 246. Accordingly, no stepped-up authentication or additional challenges may be required for authentication operation 248.

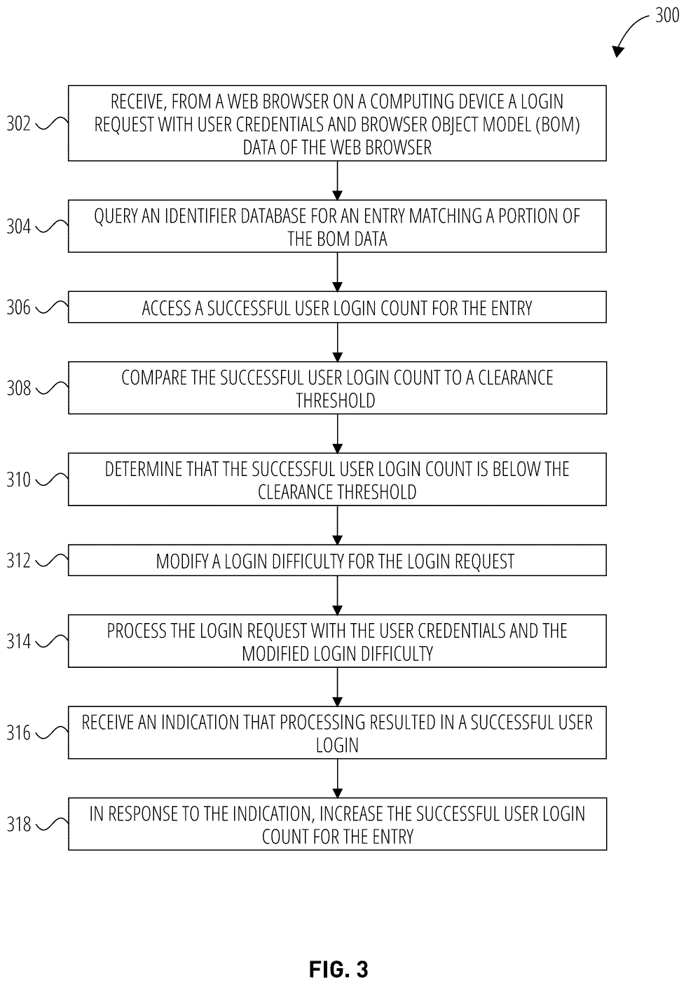

FIG. 3 is a block diagram flowchart 300 of a method to respond to login requests, according to various examples. The method is represented as a set of blocks that describe operations 302 to 318. The operations may be performed by devices such as application server 102 and client device 104 described previously. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which, when executing the set of instructions, may configure the processing unit to perform the operations illustrated in FIG. 3. The processing unit may instruct another component of a computing device to carry out the set of instructions. For example, the processing unit may instruct a network device to transmit data to another computing device or the computing device may provide data over a display interface to present a user interface. In some examples, the performance of the method may be split across multiple computing devices using a shared computing infrastructure (e.g., the processing unit encompasses multiple distributed computing devices).

At operation 302, the method may include receiving, from a web browser on a computing device, a login request with user credentials and browser object model (BOM) data of the web browser. For example, the login request may be transmitted from a client device such as client device 104 using web client 106.

The BOM data may be an identifier used in the BOM data of the web browser such as one or more keys or a key: value pairs as described in FIG. 1 and FIG. 2. In various examples, the identifier may also include a type of the value (e.g., int, string, JSON). The BOM data may be a randomly selected portion all the BOM data of the web browser. For example, one or more objects in the set of all known BOM objects may have their tree structures traversed (e.g., down as opposed to up to the head). The selection may occur at the web browser in some examples using JavaScript code executing on a web page.

The BOM data may also be prescreened to exclude previously cleared BOM identifiers. For example, the JavaScript code may compare identifiers of the BOM to a list of known cleared identifiers. The BOM data in the login request may be the identifiers that remain after the exclusion. Furthermore, the BOM data in the login request may be a hash of the underlying identifiers.

In various examples, if there are BOM identifiers remaining a browser fingerprint may be calculated and transmitted with, or separately, the login request. A browser fingerprint may be a hash of one or more values of keys in the BOM (e.g., user agent, custom keys, etc.).

At operation 304, the method may include querying an identifier database (e.g., identifier database 122) for an entry matching a portion of the BOM data. A match may refer to a key or hash included in the BOM data that matches an identifier column in the identifier database. The querying may be performed as discussed for query identifier database operation 208 in FIG. 2.

At operation 306, the method may include accessing a successful user login count for the entry. Accessing may include executing a database query to retrieve the value of the successful user login count associated with the entry that is matched at operation 304.

At operation 308, the method may include comparing the successful user login count to a clearance threshold. The clearance threshold may be part of the entry or set as a default variable for all entries. A default clearance threshold may be modified, as discussed previously in FIG. 2, using contextual data of the login request, such as geolocation data or the browser fingerprint.

At operation 310, the method may include, based on the comparison, determining that the successful user login count is below the clearance threshold. At operation 312, the method may include modifying a login difficulty for the login request. The login difficulty may be set as discussed in FIG. 2 (e.g., for assign login difficulty operation 210, assign login difficulty operation 222, etc.).

At operation 314, the method may include processing the login request with the user credentials and the modified login difficulty. For example, the login request may be processed using a stepped-up authentication with a one-time passcode.

At operation 316, the method may include receiving an indication that the processing resulted in a successful user login. The indication may be a response to an API call, in various examples. At operation 318, the method may include, in response to the indication, increasing the successful user login count for the entry.

The method may further include repeating the operations of operation 302 to operation 318 but for a second web browser, a second computing device, and a second entry in the identifier database. However, instead of using the modified login difficulty, the default login difficulty may be used based on the successful user login count meeting the clearance threshold for the second entry.

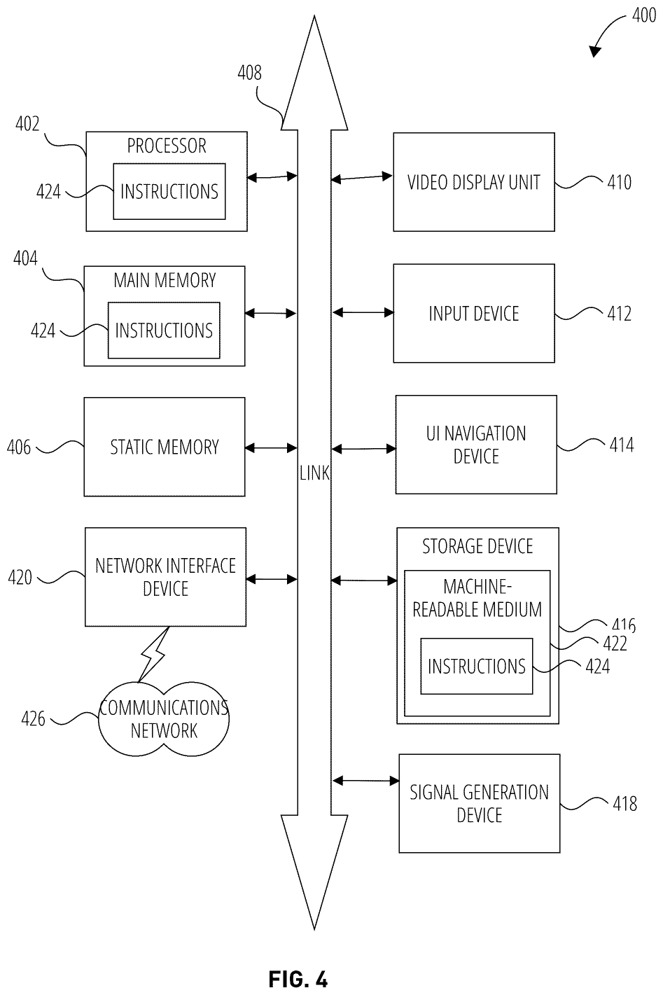

FIG. 4 is a block diagram illustrating a machine in the example form of computer system 400, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 400 includes at least one processor 402 (e.g., a central processing unit (CPU), a graphics processing unit (GPU) or both, processor cores, compute nodes, etc.), a main memory 404, and a static memory 406, which communicate with each other via a link 408. The computer system 400 may include a video display unit 410, an input device 412 (e.g., a keyboard), and a user interface UI navigation device 414 (e.g., a mouse). In an example, the video display unit 410, input device 412, and UI navigation device 414 are incorporated into a single device housing, such as a touchscreen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which one or more sets of data structures and instructions 424 (e.g., software) embodying or utilized by any of the methodologies or functions described herein. The instructions 424 may also reside, completely or at least partially, within the main memory 404, the static memory 406, or within the processor 402 during execution thereof by the computer system 400, with the main memory 404, the static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database or associated caches and servers) that store the instructions 424. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excludes transitory signals.

The instructions 424 may be transmitted or received over a communications network 426 using a transmission medium via the network interface device 420 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above, detailed description includes references to the accompanying drawings, which form a part of the detailed description. The drawings show, by way of illustration, specific embodiments that may be practiced. These embodiments are also referred to herein as “examples. ” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving, from a web browser on a computing device a login request with user credentials and browser object model (BOM) data of the web browser;
querying an identifier database for an entry matching a portion of the BOM data;
accessing a successful user login count for the entry;
comparing the successful user login count to a clearance threshold;
based on the comparison:
determining that the successful user login count is below the clearance threshold; and
modifying a login difficulty for the login request;
processing the login request with the user credentials and the modified login difficulty;
receiving an indication that the processing resulted in a successful user login; and
in response to the indication, increasing the successful user login count for the entry.

2. The method of claim 1, further comprising:
receiving, from a second web browser on a second computing device a second login request and second BOM data of the second web browser;
querying the identifier database for an entry matching a portion of the second BOM data;
accessing a successful user login count for the entry matching the portion of the second BOM data;
comparing the successful user login count for the second entry matching a portion of the second BOM data to the clearance threshold;
based on the comparison:
determining that the successful user login count for the second entry matching a portion of the second BOM data is at the clearance threshold; and
maintaining a default login difficulty for the second login request.

3. The method of claim 1, further comprising:
randomly selecting the portion of the BOM data.

4. The method of claim 1, wherein the portion of the BOM data excludes previously cleared identifiers.

5. The method of claim 4, wherein the portion of the BOM data is a hash of an identifier.

6. The method of claim 1, further comprising:
receiving the BOM data in response to JavaScript executing on a webpage.

7. The method of claim 1, further comprising:
adjusting the clearance threshold based on contextual data of the login request.

8. The method of claim 7, wherein the contextual data includes geolocation data associated with the login request.

9. The method of claim 7, wherein the contextual data includes a browser fingerprint.

10. A non-transitory computer-readable medium comprising instructions, which when executed by a processing unit, configure the processing unit to perform operations comprising:
receiving, from a web browser on a computing device a login request with user credentials and browser object model (BOM) data of the web browser;
querying an identifier database for an entry matching a portion of the BOM data;
accessing a successful user login count for the entry;
comparing the successful user login count to a clearance threshold;
based on the comparison:
determining that the successful user login count is below the clearance threshold; and
modifying a login difficulty for the login request;
processing the login request with the user credentials and the modified login difficulty;
receiving an indication that the processing resulted in a successful user login; and
in response to the indication, increasing the successful user login count for the entry.

11. The non-transitory computer-readable medium of claim 10, wherein the instructions, which when executed by the processing unit, further configure the processing unit to perform operations comprising:
receiving, from a second web browser on a second computing device a second login request and second BOM data of the second web browser;
querying the identifier database for an entry matching a portion of the second BOM data;
accessing a successful user login count for the entry matching the portion of the second BOM data;
comparing the successful user login count for the second entry matching a portion of the second BOM data to the clearance threshold;
based on the comparison:
determining that the successful user login count for the second entry matching a portion of the second BOM data is at the clearance threshold; and
maintaining a default login difficulty for the second login request.

12. The non-transitory computer-readable medium of claim 10, wherein the instructions, which when executed by the processing unit, further configure the processing unit to perform operations comprising:
randomly selecting the portion of the BOM data.

13. The non-transitory computer-readable medium of claim 10, wherein the portion of the BOM data excludes previously cleared identifiers.

14. The non-transitory computer-readable medium of claim 13, wherein the portion of the BOM data is a hash of an identifier.

15. The non-transitory computer-readable medium of claim 10, wherein the instructions, which when executed by the processing unit, further configure the processing unit to perform operations comprising:
receiving the BOM data in response to JavaScript executing on a webpage.

16. The non-transitory computer-readable medium of claim 10, wherein the instructions, which when executed by the processing unit, further configure the processing unit to perform operations comprising:
adjusting the clearance threshold based on contextual data of the login request.

17. The non-transitory computer-readable medium of claim 16, wherein the contextual data includes geolocation data associated with the login request.

18. The non-transitory computer-readable medium of claim 16, wherein the contextual data includes a browser fingerprint.

19. A system comprising:
a processing unit;
a storage device comprising instructions, which when executed by the processing unit, configure the processing unit to perform operations comprising:
receiving, from a web browser on a computing device a login request with user credentials and browser object model (BOM) data of the web browser;
querying an identifier database for an entry matching a portion of the BOM data;
accessing a successful user login count for the entry;
comparing the successful user login count to a clearance threshold;
based on the comparison:
determining that the successful user login count is below the clearance threshold; and
modifying a login difficulty for the login request;
processing the login request with the user credentials and the modified login difficulty;
receiving an indication that the processing resulted in a successful user login; and
in response to the indication, increasing the successful user login count for the entry.

20. The system of claim 19, wherein the instructions, which when executed by the processing unit, further configure the processing unit to perform operations comprising:
receiving, from a second web browser on a second computing device a second login request and second BOM data of the second web browser;
querying the identifier database for an entry matching a portion of the second BOM data;
accessing a successful user login count for the entry matching the portion of the second BOM data;
comparing the successful user login count for the second entry matching a portion of the second BOM data to the clearance threshold;
based on the comparison:
determining that the successful user login count for the second entry matching a portion of the second BOM data is at the clearance threshold; and
maintaining a default login difficulty for the second login request.
